(19) United States
(12) Patent Application Publication
(10) Pub. No.: US 2019/0362065 A1
(43) Pub. Date: Nov. 28, 2019

(54) PASSWORD INPUT SYSTEM INCLUDED IN IC CARD AND PASSWORD INPUT METHOD INCLUDED IN IC CARD

(71) Applicant: SHANGHAI FINANASIA INC., Shanghai (CN)

(72) Inventor: Shaw Dong XIAO, Shanghai (CN)

(21) Appl. No.: 16/477,941

(22) PCT Filed: Jan. 9, 2018
(86) PCT No.: PCT/CN2018/071914

§ 371 Date: Jul. 15, 2019

(30) Foreign Application Priority Data
Jan. 16, 2017 (CN) 201710028208.8

(51) Int. Cl. G06F 21/36; G06F 21/46; G06F 3/0488; G06Q 20/34; G06Q 20/38; G06Q 20/40; G06Q 20/32

(52) U.S. Cl. CPC G06F 21/36; G06F 21/46; G06F 3/04883; G06Q 20/322; G06Q 20/382; G06Q 20/4014; G06Q 20/34

(57) ABSTRACT

A password input system included in IC card and a password input method included in IC card. The password input system included in IC card comprises: an IC card, a mobile terminal, a payment terminal and a cloud end; the IC card is provided with an input module for inputting a first password, a processor module connected with the input module, and a communication module connected with the processor module, the communication module establishing a communication connection with the cloud end via the payment terminal; the mobile terminal is in communication connection with the cloud end, and the mobile terminal is used for sending a second password input and set on the mobile terminal to the cloud end after passing an identity verification by the cloud end; and the cloud end is used for storing a third password, and is further used for updating the stored third password according to the second password, and comparing the first password input into the IC card with the third password. The password input system included in IC card and the password input method included in IC card are more secure.

### CROSS-REFERENCE TO RELATED APPLICATIONS

The present application is a national phase application of International Patent Application No. PCT/CN2018/071914, filed on Jan. 9, 2018, which claims priority of Chinese Patent Application No. CN201710028208.8, filed on Jan. 16, 2017, the entire contents of which are incorporated herein by reference.

### TECHNICAL FIELD

The present invention relates to the field of financial payment cards, and particularly to a password input system integrated into IC cards and a password input method particularly designed for IC cards.

### BACKGROUND

An IC card (Integrated Circuit Card) is also called a Smart card, an Intelligent card, an NFC card (a card employing Near Field Communication Technology), a microchip card or the like, in which a microelectronic chip is embedded in a card base to form a card having multiple functions. Due to its inherent advantages such as information security, portability, relatively complete standardization and the like, the IC card has been widely applied in the fields such as identify authentication, bank payment, public transportation, and access control.

For security reasons, when an IC card is used for a payment transaction, it is usually required to enter a password. Currently, due to the limitations of hardware and software, it is usually required to enter a password on a payment terminal such as a POS machine, and entering the password on the payment terminal may bring many problems:

1. increasing security risks: a malicious merchant or third party may steal a user's password by modifying the payment terminal or peeping;

2. increasing transaction time: since the user inputs the password on unfamiliar hardware devices, he or she needs to be familiar with a different device every time, and the transaction and password input need to be synchronized, which increases the transaction time; and

3. insanitation: because the health status of the payment terminal is worrying, it is easy to spread bacteria through the user's finger, affecting the user experience.

In Chinese utility model patent with Application No. CN200420014345.4, a bank card with a built-in keyboard is disclosed, wherein a keyboard, a memory microchip, a control circuit microchip, an interface and a miniature long-life lithium battery are embedded in the bank card, the keyboard is connected with the memory microchip, the memory microchip is connected with the interface, the interface is further connected with the control circuit microchip, the control circuit microchip is also separately connected with the keyboard and the memory microchip, and the miniature long-life lithium battery is connected to the memory microchip and the control circuit microchip.

As mentioned in the utility model, in a process of using the bank card with the built-in keyboard, before withdrawing money, a depositor needs to enter data such as a password, an amount of withdrawal and the like with the keyboard built in the bank card at home or another relatively secure place, such that the card temporarily saves these data.

Thereafter, the depositor goes to a teller machine and inserts the bank card with the built-in keyboard into the teller machine, and then the card automatically transmits the data such as the password, the amount of the withdrawal and the like to the teller machine. Upon completion of the withdrawal, the teller machine gives a clearing signal to the card such that the data such as the password and the like in the card is cleared.

In Chinese invention patent application with Application No. CN201010502426.9, a bank card with input and output functions is also disclosed. Similarly to the aforementioned patent, the bank card is also provided with a storage module for a user to store bank card personal security information and a bank card personal identification password, and the payment is realized by verifying the information.

However, none of these payment systems is perfect. In these patents, a user can input a password, a computing chip on a card can verify whether or not the password input by the user is correct, and even in some of these patents, it is possible to modify, in a case where an old password is known, the password into a new password. However, how to set an initial password and how to reset a password (in a case where the user reasonably forgets the password) are not involved in the aforementioned patents. These password setting and resetting functions are just an important constituent part of a password security system. Further, it is presently neither realistic nor secure to realize the password setting and resetting functions depending only on the limited input, display and communication capabilities on an IC card.

### SUMMARY

It is an object of the present invention to provide a password input system integrated into IC cards and a password input method particularly designed for IC cards. The IC card with password input system and using the password input method designed for cards is much more secure.

To solve the aforementioned technical problem, the present invention provides a password input system integrated into IC cards, comprising: an IC card, a mobile terminal, a payment terminal and a cloud end;
wherein, the IC card is provided with an input module for inputting a first password, a processor module connected with the input module, and a communication module connected with the processor module, the communication module establishing a communication connection with the cloud end via the payment terminal;
the mobile terminal is in communication connection with the cloud end, and the mobile terminal is used for sending a second password input and set on the mobile terminal to the cloud end after passing an identity verification by the cloud end;
the cloud end is used for storing a third (cloud) password, and is further used for updating the stored third password according to the second password and comparing the first password input into the IC card with the third password; and
if the first password is the same as the third password, an authentication is passed and then the cloud end processes a content such as a message forwarded by the payment terminal; and if the first password is different from the third password, the authentication fails and the cloud end does not process a message forwarded by the payment terminal.

The present invention further provides a password input method integrated into IC cards, characterized by comprising the following steps:
establishing, by a mobile terminal and an APP, a communication connection with a cloud end;
passing an identity verification for the mobile terminal by the cloud end;
sending, by the mobile terminal, a second password to the cloud end and updating, by the cloud end, a stored third password based on the second password;
establishing, by a communication module of an IC card, a communication connection with the cloud end directly or via a payment terminal;
inputting a first password into an input module of the IC card and sending, by the communication module of the IC card, the first password to the cloud end directly or via the payment terminal; and
comparing the first password and the third password in the cloud end, wherein if the first password is the same as the third password, an authentication is passed and then the cloud end processes a message forwarded by the payment terminal; and if the first password is different from the third password, the authentication fails and the cloud end does not process a message forwarded by the payment terminal.

Compared with current technologies, the present invention solves the security, convenience and user-experience problems systematically and comprehensively.

Firstly, in the present invention, a user only needs to input a password on his own IC card and is very familiar with his own device, and the password input and the transaction may be asynchronously performed (it allows the transaction to be performed within several minutes after the password is input), thus making it possible to complete a payment process more quickly, and providing better convenience.

Secondly, since the IC card is personally customized, problems such as insanitation are excluded, thus improving the user-experience.

As a preference, the input module comprises N touch points formed into a matrix on a surface of the IC card, where N is a natural number greater than or equal to 4. It is worth mentioning that in some existing technology, it is proposed to embed a fingerprint identification module on a bank card/credit card for anti-counterfeiting authentication. However, the power-consumption and cost of such a module will be significantly higher than that of the password input module of the present patent.

When the number of the touch points is greater than or equal to 4, a password can be formed by a pattern-lock. Therefore, as a preference, in the step of inputting a first password into an input module of the IC card, the input module recognizes the input password according to a pattern drawn by a finger on the touch points. When the same touch points is allowed to be used repeatedly, 4 or more touch points are enough to form a password with great enough complexity. Also, when the number of the touch points is 4, the password is very easy to remember and is easy to input.

Further, as a preference, N is equal to 9, and the touch points form a nine-square grid on the surface of the IC card. The touch points forming the nine-square grid are in line with the existing pattern-lock, fully taking into account the user-experience and acceptance.

In addition, as a preference, the IC card is further provided with a battery for supplying power to the input module and the processor module. When the independent power supply is provided, the time of use of the input module may be more flexible.

Further, as a preference, the IC card is further provided with a solar charging panel or a solar charging film for charging the battery. Considering that power consumptions of both the input module and the processor module are not high, solar-energy would be very convenient.

Further, as a preference, the third password stored by the cloud end is a one-way hash value of the third password. When the one-way hash value of the third password is stored by the cloud end, it is only necessary to compare the one-way hash values of the first password and the third password in order to realize the authentication of the passwords, thus providing better security.

Further, as a preference, in the step of sending the second password to the cloud end by the mobile terminal, and updating by the cloud end, the stored third password based on the second password:
The cloud end calculates a one-way hash value of the second password and updates the one-way hash value of the stored third password.

In this case, the second password and the third password are not recorded in the cloud end, such that the passwords themselves will not be revealed even if the data is stolen.

Alternatively, the mobile terminal calculates a one-way hash value of the second password and sends the one-way hash value of the second password to the cloud end, and the cloud end updates the one-way hash value of the stored third password according to the received one-way hash value of the second password.

In this case, the second password itself is also not recorded in the mobile terminal, and the second password itself will not appear in a communication channel of the mobile terminal with the cloud end either, thus effectively reducing a risk of the second password to be stolen.

Also, as a preference, in the step of comparing, by the cloud end, the first password and the third password, the cloud end calculates a one-way hash value of the first password and compares the one-way hash value of the first password with the one-way hash value of the third password.

In this case, the first password and the third password are also not recorded in the cloud end either, thus improving the security of data.

Alternatively, in the steps of sending, by the processor module of the IC card, the first password to the cloud end via the communication module of the IC card end and comparing the first password and the third password in the cloud end, the processor module calculates a one-way hash value of the first password and sends the one-way hash value of the first password to the cloud end, and the cloud end compares the one-way hash value of the first password with the one-way hash value of the third password.

In this case, the one-way hash value of the first password that is calculated via the processor module is sent to the cloud end after passing through the payment terminal, and since only the one-way hash value of the first password is received on the payment terminal, the security can be greatly improved, thus effectively reducing a risk of stealing the passwords through a forged or refitted payment terminal.

### BRIEF DESCRIPTION OF DRAWINGS

FIG. 1 is a system block diagram of a password input system included in IC according to a first embodiment of the present invention;

FIG. 2 is a front schematic view of an IC card according to a second embodiment of the present invention;

FIG. 3 is a front schematic view of an IC card according to a third embodiment of the present invention;

FIG. 4 is a side schematic view of an IC card according to a fifth embodiment of the present invention;

FIG. 5 is a front schematic view of an IC card according to a sixth embodiment of the present invention; and

FIG. 6 is a flowchart of a password input method included in IC card according to a seventh embodiment of the present invention.

### DESCRIPTION OF THE REFERENCE SIGNS

1—touch sheet; 2—display screen; 3—solar charging panel.

### DETAILED DESCRIPTION OF THE EMBODIMENTS

### First Embodiment

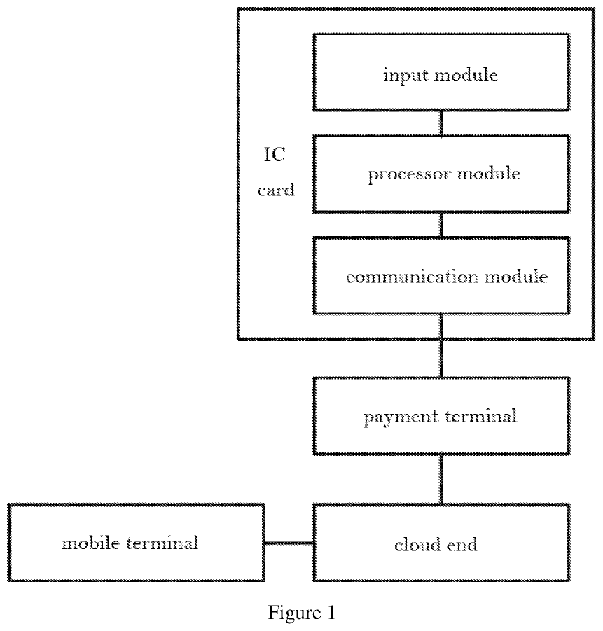

A first embodiment of the present invention provides a password input system included in IC card, as shown in FIG. 1, comprising: an IC card, a mobile terminal, a payment terminal and a cloud end;
wherein, the IC card is provided with an input module for inputting a first password, a processor module connected with the input module, and a communication module connected with the processor module, the communication module establishing a communication connection with the cloud end via the payment terminal;
the mobile terminal is in communication connection with the cloud end, and the mobile terminal is used for sending a second password input and set on the mobile terminal to the cloud end after passing an identity verification by the cloud end;
the cloud end is used for storing a third password, and is further used for updating the stored third password according to the second password and comparing the first password input into the IC card with the third password; and
if the first password is the same as the third password, an authentication is passed and then the cloud end processes a message forwarded by the payment terminal; and if the first password is different from the third password, the authentication is fails and the cloud end does not process a message forwarded by the payment terminal.

In the present embodiment, the third password stored by the cloud end may be a default initial password. Upon receipt of the second password sent by the mobile terminal, the stored third password can be updated according to the second password. As far as the specific updating manner is concerned, those ordinarily skilled in the art may make a selection according to the password technologies in the prior art. For example, most simply, it is possible to select to erase an original third password and use the content of the second password as a new third password, and it is also possible to calculate, according to the content of the second password, a feature value (e.g., a one-way hash value or other correlation values capable of realizing a check function) of the second password corresponding thereto and use the feature value as the content of the new third password, etc.

Also, in the present embodiment, the comparison of the first password with the third password may be either a comparison in terms of password contents or a comparison in terms of password feature values. When the authentication is passed, the payment terminal forwards the content of communication of the IC card with the cloud end, which may be a communication content related to payment, thereby implementing a payment action through the IC card.

Compared with the prior art, the present invention attempts to solve the aforementioned problems of security, convenience and experience from a system level.

Firstly, in the present invention, a user only needs to input a password on his own IC card and is very familiar with his own device, and the password input and the transaction may be asynchronously performed (it allows the transaction to be performed within several minutes after the password is input), thus making it possible to complete a payment process more quickly, and providing better convenience.

Secondly, since the IC card is personally customized, problems such as insanitation and the like are excluded, thus improving the user experience.

### Second Embodiment

A second embodiment of the present invention provides a password input system included in IC card. The second embodiment is a further improvement to the first embodiment, with the main improvement lying in that: in the second embodiment of the present invention, the input module comprises N touch points 1 formed into an array on a surface of the IC card, where N is a natural number greater than or equal to 4.

When the number of the touch points 1 is greater than or equal to 4, a password can be formed by drawing a pattern on the touch points 1. In the present embodiment, as shown in FIG. 2, the number of the touch points 1 is equal to 4. In the step in which a first password is input into the input module of the IC card, the input module recognizes the input password according to a pattern drawn by a finger on the touch points 1. When the same touch point is allowed to be used many times in one set of passwords, 4 or more touch points are enough to form a password with sufficient complexity. Also, when the number of the touch points 1 is 4, the password is very easy to remember and is easy to input.

Of course, in the present embodiment, the number of the touch points 1 is obviously not limited to 4. In view of costs and universality, 4 to 12 are relatively appropriate for the number of the touch points 1.

It is worth mentioning that in some prior art, it is proposed to embed a fingerprint identification module on a bank card/credit card for anti-counterfeiting authentication. However, the cost of such a module will be significantly higher than that of the password input module of the present patent.

### Third Embodiment

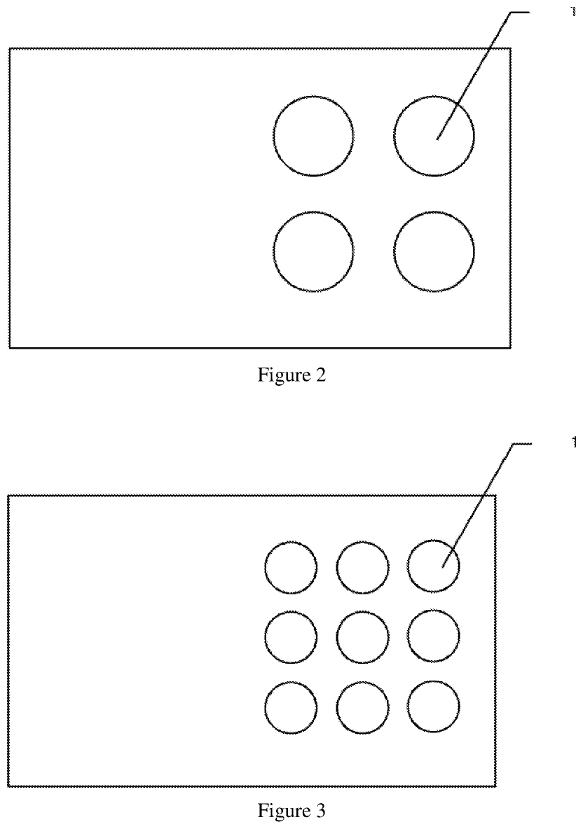

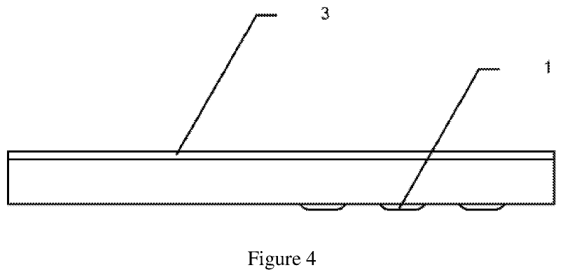

A third embodiment of the present invention provides a password input system included in IC card. The third embodiment is somewhat different from the first embodiment, with the main difference lying in that: in the second embodiment of the present invention, the number of the touch points 1 is equal to 4, whereas in the third embodiment of the present invention, as shown in FIG. 3, the number of the touch points 1 is equal to 9.

The touch points 1 form a nine-point matrix on the surface of the IC card. The touch points 1 forming the nine-point matrix are in line with the existing pattern lock, fully taking into account the user experience and acceptance.

### Fourth Embodiment

A fourth embodiment of the present invention provides a password input system included in IC card. The fourth embodiment is a further improvement of the first to third embodiments, with the main improvement lying in that: in the fourth embodiment of the present invention, the IC card is further provided with a battery for supplying power to the input module and the processor module. When the independent power supply is provided, the time of use of the input module may be more flexible.

### Fifth Embodiment

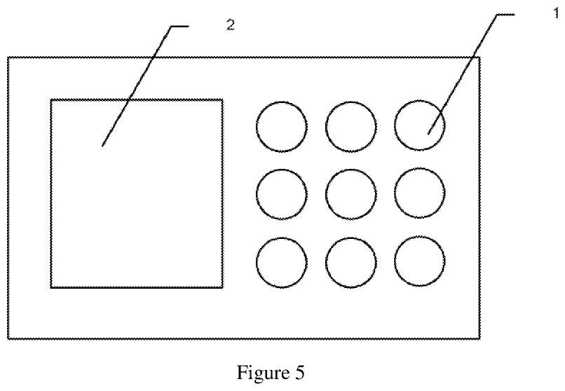

A fifth embodiment of the present invention provides a password input system included in IC card. The fifth embodiment is a further improvement of the fourth embodiment, with the main improvement lying in that: in the fifth embodiment of the present invention, as shown in FIG. 4, the IC card is further provided with a solar charging panel 3 or a solar charging film for charging the battery. Considering that the power consumptions of both the input module and the processor module are not high, with solar charging, the power is enough to be ensured and charging is also very convenient.

It is worth mentioning that, in the present embodiment, the solar charging panel 3 or the solar charging film is provided on an opposite side to the input module. Since the input module occupies quite a part of the surface area of the IC card and the surface area of the solar charging panel 3 directly determines its charging efficiency, the solar charging panel 3 or solar charging film provided on the opposite side to the input module may enable the solar charging panel 3 or the solar charging film to occupy a larger area, thereby obtaining a quicker charging rate.

### Sixth Embodiment

A sixth embodiment of the present invention provides a password input system included in IC card. The sixth embodiment is a further improvement of the fifth embodiment, with the main improvement lying in that: in the sixth embodiment of the present invention, as shown in FIG. 5, the IC card is further provided with a display screen 2 being in communication connection with the processor module; and the display screen 2 is used for displaying transaction confirmation information sent by a payment device.

It is worth mentioning that, in the present embodiment, the display screen 2 is provided on the same side as the input module, and the transaction confirmation information is displayed by means of the display screen 2, such that a user can always pay attention on the IC card in a process from inputting a password to confirming a transaction, thereby effectively preventing other persons from peeping at the password.

### Seventh Embodiment

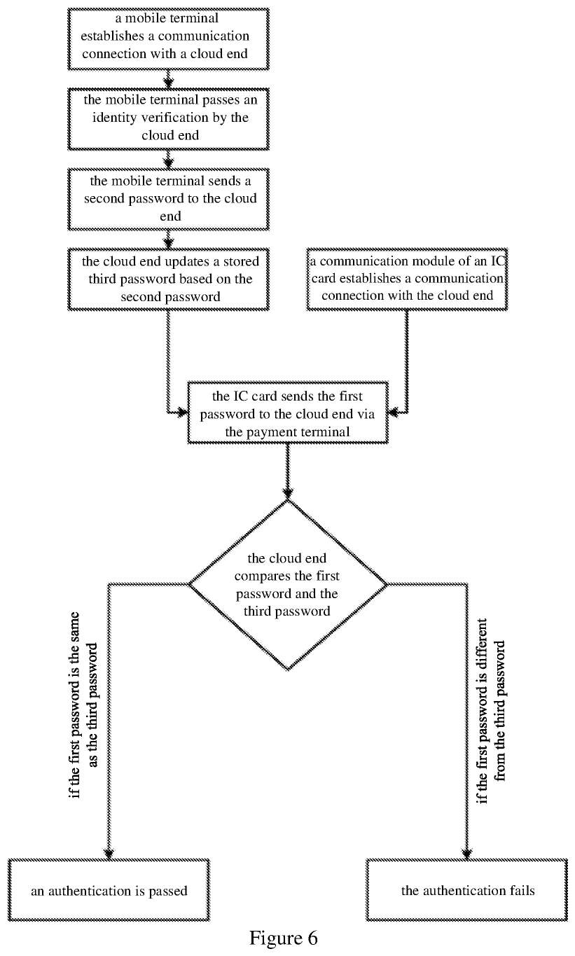

A seventh embodiment of the present invention provides a password input system included in IC card, as shown in FIG. 6, comprising the following steps:
establishing, by a mobile terminal, a communication connection with a cloud end;
passing an identity verification for the mobile terminal by the cloud end;
sending, by the mobile terminal, a second password to the cloud end, and updating, by the cloud end, a stored third password based on the second password;
establishing, by a communication module of an IC card, a communication connection with the cloud end via a payment terminal;
inputting a first password into an input module of the IC card and sending, by the communication module of the IC card, the first password to the cloud end via the payment terminal; and
comparing, by the cloud end, the first password and the third password, wherein if the first password is the same as the third password, an authentication is passed and then the cloud end processes a message forwarded by the payment terminal; and if the first password is different from the third password, the authentication fails and the cloud end does not process a message forwarded by the payment terminal

It is worth mentioning that, in the present embodiment, the step “establishing, by a communication module of the IC card, the communication connection with the cloud end” may take place at any timing before the step “inputting the first password into the input module of the IC card and sending, by the communication module of the IC card, the first password to the cloud end via the payment terminal”, and the order of the steps is not strictly limited. For example, the mobile terminal may first establish a communication connection with the cloud end, the third password is updated and then the step “establishing, by the communication module of the IC card, a communication connection with the cloud end” is performed. Alternatively, the third password is not updated and the old third password may be directly used to perform the verification and comparison with the first password.

In the present embodiment, the third password stored by the cloud end may be a default initial password. Upon receipt of the second password sent by the mobile terminal, the stored third password can be updated according to the second password. As far as the specific updating manner is concerned, those ordinarily skilled in the art can make a selection according to the password technologies in the prior art. For example, most simply, it is possible to select to erase an original third password and use the content of the second password as a new third password, and it is also possible to calculate, according to the content of the second password, a feature value (e.g., a one-way hash value or other correlation values capable of realizing a check function) of the second password corresponding thereto and use the feature value as the content of the new third password, etc.

Also, in the present embodiment, the comparison of the first password with the third password may be either a comparison in terms of password contents or a comparison in terms of password feature values. When the authentication is passed, the payment terminal forwards content of communication of the IC card with the cloud end, which may be a communication content related to payment, thereby implementing a payment action through the IC card.

Compared with the prior art, the present invention attempts to solve the aforementioned problems of security, convenience and experience from a system level.

Firstly, the present invention improves data processing efficiency by providing a cloud end and uniformly managing password data of a user by the cloud end. Through interactions between the cloud end and the mobile terminal, it is made possible to modify a password at the cloud end through the mobile terminal, thus providing better privacy. In the present invention, the user inputs a password from the IC card, the payment terminal forwards the password input from the IC card, and the cloud end verifies the password from the IC card. Since it is not necessary to store the user's password in the IC card, better security is provided.

Secondly, in the present invention, the user only needs to input a password on his own IC card, and is very familiar with his own device, thus making it possible to complete a payment process more quickly, and providing better convenience.

Thirdly, since the IC card is personally customized, problems such as insanitation and the like are excluded, thus improving the user experience.

### Eighth Embodiment

An eighth embodiment of the present invention provides a password input system included in IC card. The eighth embodiment is a further improvement of the seventh embodiment, with the main improvement lying in that: in the eighth embodiment of the present invention: the third password stored by the cloud end is a one-way hash value of the third password. When the one-way hash value of the third password is stored by the cloud end, it is only necessary to compare the one-way hash values of the first password and the third password in order to realize the authentication of the passwords, thus providing better security.

Specifically speaking, in the step in which the mobile terminal sends a second password to the cloud end and the cloud end updates the stored third password based on the second password:
the cloud end calculates a one-way hash value of the second password and updates the one-way hash value of the stored third password.

In this case, the second password and the third password are not recorded in the cloud end, such that the passwords themselves will not be leaked even if the data is stolen.

It is worth mentioning that, the one-way hash value referred to in the present embodiment may be an MD5 code, an SHA-256 code or the like.

### Ninth Embodiment

A ninth embodiment of the present invention provides a password input method included in IC card. The ninth embodiment is somewhat different from the eighth embodiment, with the main difference lying in that: in the eighth embodiment of the present invention, the one-way hash value of the second password is calculated by the cloud end, whereas in the ninth embodiment of the present invention, the one-way hash value of the second password is calculated by the mobile terminal.

In the step in which the mobile terminal sends a second password to the cloud end and the cloud end updates the stored third password based on the second password: the mobile terminal calculates the one-way hash value of the second password and sends the one-way hash value of the second password to the cloud end, and the cloud end updates the one-way hash value of the stored third password according to the received one-way hash value of the second password.

In this case, the second password itself is also not recorded in the mobile terminal, and the second password itself does not appear in a communication channel of the mobile terminal with the cloud end, thus effectively reducing a risk of the second password to be stolen.

### Tenth Embodiment

A tenth embodiment of the present invention provides a password input method included in IC card. The tenth embodiment is a further improvement to any one of the seventh to ninth embodiments, with the main improvement lying in that: in the tenth embodiment of the present invention, in the step in which the cloud end compares the first password and the third password, the cloud end calculates the one-way hash value of the first password and compares the one-way hash value of the first password with the one-way hash value of the third password.

In this case, the first password and the third password are also not recorded in the cloud end, thus improving the security of data.

### Eleventh Embodiment

An eleventh embodiment of the present invention provides a password input method included in IC card. The eleventh embodiment is somewhat different from the tenth embodiment, with the main difference lying in that: in the tenth embodiment of the present invention, the one-way hash value of the first password is calculated by the cloud end, whereas in the eleventh embodiment of the present invention, the one-way hash value of the first password is calculated by the processor module.

Specifically speaking, in the steps in which the processor module of the IC card sends the first password to the cloud end via the communication module of the IC card end and in which the cloud end compares the first password and the third password, the processor module calculates the one-way hash value of the first password and sends the one-way hash value of the first password to the cloud end via the payment terminal, and the cloud end compares the one-way hash value of the first password with the one-way hash value of the third password.

In this case, the one-way hash value of the first password that is calculated via the processor module is sent to the cloud end after passing through the payment terminal, and since the payment terminal only receives the one-way hash value of the first password, the security can be greatly improved, thus effectively reducing a risk of stealing the passwords through a forged or refitted payment terminal.

### Twelfth Embodiment

A twelfth embodiment of the present invention provides a password input method included in IC card. The twelfth embodiment is a further improvement to any one of the seventh to eleventh embodiment, with the main improvement lying in that: in the twelfth embodiment of the present invention, after the step in which the communication module establishes the communication connection with the payment device and before the step in which the password is input into the input module, the following step is further comprised.

The processor module obtains transaction confirmation information from a payment device, and sends the transaction confirmation information to a display screen 2. The transaction confirmation information is displayed by means of the display screen 2, such that a user can always pay attention on the IC card in the process from inputting a password to confirming a transaction, thereby effectively preventing other persons from peeping at the password.

Those ordinarily skilled in the art would appreciate that, in the aforementioned respective embodiments, many technical details have been proposed in order to enable a reader to better understand the present application. However, even without these technical details and various variations and modifications carried out based on the aforementioned respective embodiments, it is possible to substantially realize the technical solutions claimed in the respective claims of the present application. Therefore, in the practical applications, various changes may be carried out for the aforementioned embodiments in terms of form and detail, without departing from the spirit and scope of the present patent.

What is claimed is:

1. A password input system included in IC card, comprising: an IC card, a mobile terminal, a payment terminal and a cloud end;
wherein, the IC card is provided with an input module for inputting a first password, a processor module connected with the input module, and a communication module connected with the processor module, the communication module establishing a communication connection with the cloud end via the payment terminal;
the mobile terminal is in communication connection with the cloud end, and the mobile terminal is used for sending a second password input and set on the mobile terminal to the cloud end after passing an identity verification by the cloud end;
the cloud end is used for storing a third password, and is further used for updating the stored third password according to the second password and comparing the first password input into the IC card with the third password; and
if the first password is the same as the third password, an authentication is passed and then the cloud end processes a message forwarded by the payment terminal; and if the first password is different from the third password, the authentication is failed and the cloud end does not process a message forwarded by the payment terminal.

2. The password input system included in IC card according to claim 1, characterized in that the input module comprises N touch points formed as an array on a surface of the IC card, where N is a natural number greater than or equal to 4.

3. The password input system included in IC card according to claim 2, characterized in that the N is equal to 9, and the touch points form a nine-square grid on the surface of the IC card.

4. The password input system included in IC card according to claim 1, characterized in that the IC card is further provided with a battery for supplying power to the input module and the processor module.

5. The password input system included in IC card according to claim 4, characterized in that the IC card is further provided with a solar charging panel or a solar charging film for charging the battery.

6. A password input method included in IC card, characterized by comprising the following steps:
establishing, by a mobile terminal, a communication connection with a cloud end;
passing an identity verification for the mobile terminal by the cloud end;
sending, by the mobile terminal, a second password to the cloud end, and updating, by the cloud end, a stored third password based on the second password;
establishing, by a communication module of an IC card, a communication connection with the cloud end via a payment terminal;
inputting a first password into an input module of the IC card and sending, by the communication module of the IC card, the first password to the cloud end via the payment terminal; and
comparing, by the cloud end, the first password and the third password, wherein if the first password is the same as the third password, an authentication is passed and then the cloud end processes a message forwarded by the payment terminal; and if the first password is different from the third password, the authentication fails and the cloud end does not process a message forwarded by the payment terminal.

7. The password input method included in IC card according to claim 6, characterized in that the third password stored by the cloud end is a one-way hash value of the third password.

8. The password input method included in IC card according to claim 7, characterized in that in the step of sending, by the mobile terminal, the second password to the cloud end, and updating, by the cloud end, the stored third password based on the second password:
the cloud end calculates a one-way hash value of the second password and updates the one-way hash value of the stored third password;
or, the mobile terminal calculates a one-way hash value of the second password and sends the one-way hash value of the second password to the cloud end, and the cloud end updates the one-way hash value of the stored third password according to the received one-way hash value of the second password.

9. The password input method included in IC card according to claim 7, characterized in that in the step of comparing, by the cloud end, the first password and the third password, the cloud end calculates a one-way hash value of the first password and compares the one-way hash value of the first password with the one-way hash value of the third password;
or, in the steps of sending, by a processor module of the IC card, the first password to the cloud end via the communication module of the IC card and comparing, by the cloud end, the first password and the third password, the processor module calculates a one-way hash value of the first password and sends the one-way hash value of the first password to the cloud end via the payment terminal, and the cloud end compares the one-way hash value of the first password with the one-way hash value of the third password.

10. The password input method included in IC card according to claim 6, characterized in that in the step of inputting a first password into an input module of the IC card, the input module recognizes the input password according to a pattern drawn by a finger on touch points.
